(19) United States
(12) Patent Application Publication
(10) Pub. No.: US 2014/0013810 A1
(43) Pub. Date: Jan. 16, 2014

(54) DEVICE SECURITY SYSTEM

(71) Applicant: DCI Marketing, Inc., Milwaukee, WI (US)

(72) Inventors: Ryan Brobst, Cedarburg, WI (US); Andrew Dunkerley, Loughborough Leicestershire (GB); Jody Neal, Loughborough Leicestershire (GB)

(73) Assignee: DCI Marketing, Inc., Milwaukee, WI (US)

(21) Appl. No.: 13/941,035

(22) Filed: Jul. 12, 2013

Related U.S. Application Data
(60) Provisional application No. 61/671,010, filed on Jul. 12, 2012.

(51) Int. Cl. E05B 73/00

(52) U.S. Cl. CPC E05B 73/0082
USPC 70/58; 29/428

(57) ABSTRACT

An electronic device security system allows an authorized user to quickly remove an electronic device from an advertising display. The electronic device security system includes a plurality of retention tabs to secure the tablet computer and an electronic lock and motor to raise a tablet lift pad to release the device.

### CROSS-REFERENCE TO RELATED APPLICATION

This application is based on and claims priority to U.S. Provisional Patent Application No. 61/671,010 filed on Jul. 12, 2012, which is incorporated herein by reference in its entirety for all purposes.

### FIELD OF THE INVENTION

The present invention relates generally to the field of advertising displays. More particularly, the present invention relates to a display device for displaying and powering an electronic device such as a tablet computer (“tablet”) to allow it to be manipulated by a user while also prohibiting the unauthorized removal of the tablet from the display device.

### BACKGROUND

In the field of advertising displays, particularly informational kiosks, there is a need to display a tablet in a way that allows consumers to touch and control the tablet, yet prevents the tablet from unauthorized removal. Typically, such tablet advertising displays employ either a mechanical lock or adhesive to secure the tablet to the display. The mechanical locks usually include a plurality of tabs or bars that secure the tablet, and may only be removed with a key or using a tool such as a screwdriver or allen wrench. Removing the tablet from a display including a mechanical or adhesive attachment solution is an involved process that cannot be done quickly or easily on the retail floor, especially in front of customers. In the case of adhesive attachment solutions, once the adhesive is attached to the tablet, it is very difficult, if not impossible, to remove it without damaging the tablet.

The need also exists to allow a sales representative or other authorized employee to easily remove the tablet from its display so that the employee may use and/or take the tablet with him while engaged with a customer. Such a display would be useful in any number of retail settings. For example, the display could be used in an auto dealership, where a tablet would be mounted to a kiosk next to a vehicle in the showroom. A customer could approach the kiosk, where the tablet would display information about the vehicle, and may allow the customer to learn more about the vehicle or configure one with the customer's desired options. Next, when a sales person approached the customer at the kiosk he could remove the tablet from the kiosk for a more engaging sales presentation. Another example where such a display would be useful are in-store retail displays. Again, the display would secure a tablet next to products, where the tablet would provide pertinent information to customers, and allow the customer to interact with the tablet to obtain additional information. An employee or other authorized user could then remove the tablet from the display to better demonstrate the product or provide a more engaging sales presentation to the customer.

As such, there is a need for a device security system that secures an electronic device such as a tablet to a display that also provides power to the tablet, and allows only an employee or other authorized user to remove the tablet from the display.

### SUMMARY

The present invention relates to an electronic device security system (for, e.g., a tablet computer) having a tablet lift pad connected to a housing by at least one hinge and configured to support a tablet computer. The tablet computer security system further includes an electronic lock attached to the housing beneath the tablet lift pad. The electronic lock selectively locks or unlocks the tablet lift pad to the housing. A switch actuates the electronic lock. The housing further includes a tablet lift mechanism that lifts the tablet lift pad to a raised position when the electronic lock is unlocked. A plurality of retention tabs secure a tablet computer to the tablet lift pad when the tablet lift pad is in a locked position.

The tablet computer security system can include a power connector that provides power to the tablet computer through a charging clip that is connected to the tablet computer and adapts the power connector on the tablet computer to connect to the power connector on the security system.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of a device security system in accordance with the invention;

FIG. 2 is an exploded perspective view of the device security system of FIG. 1;

FIG. 3 is a perspective view of the device security system of FIG. 1;

FIG. 4 is a partially exploded perspective view of the device security system of FIG. 1;

FIG. 5 is a section view of the device security system of FIG. 1 taken generally along the line 5-5 in FIG. 4; and

FIG. 6 is another exploded perspective view of the device security system of FIG. 1.

### DETAILED DESCRIPTION

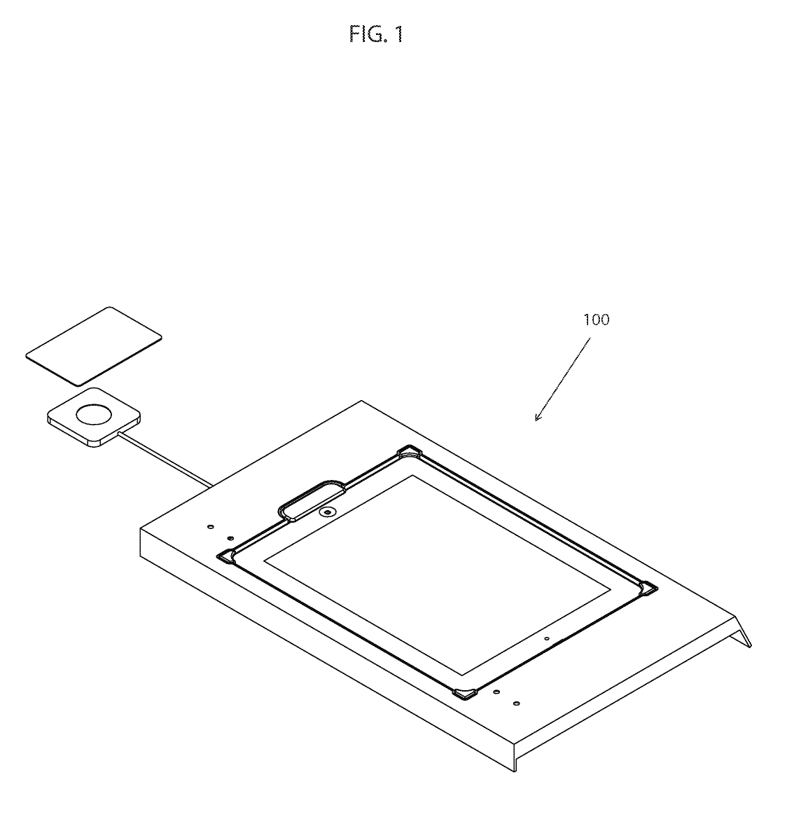

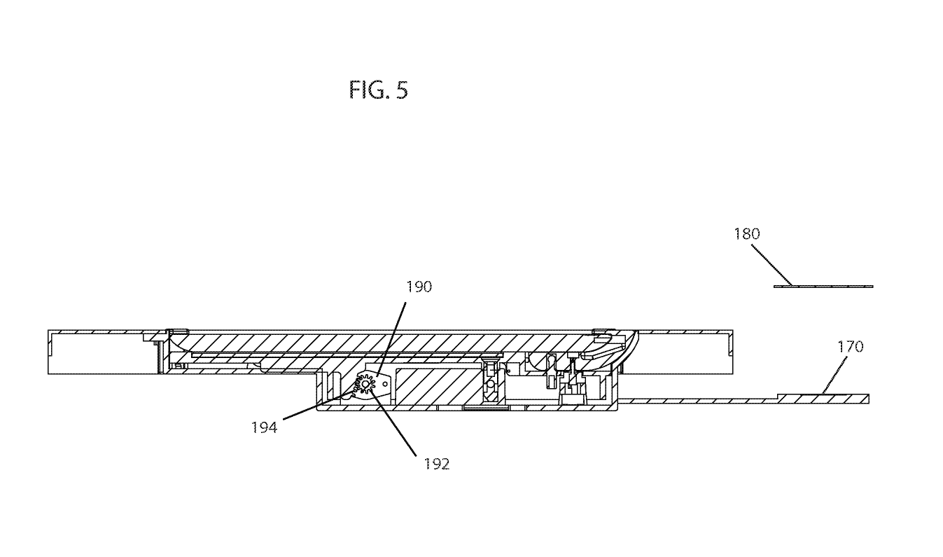

FIGS. 1-6 show one embodiment of an electronic device security system 100 in accordance with the invention. The tablet security system 100 includes a housing 110, a tablet lift pad 120, an electronic lock 130, a lock pin 135, at least one retention tab 140, a charging clip 150, power connector 160, card reader 170, and access card 180. The tablet security system 100 securely displays a tablet 200 such that a user may use the access card 180 to release the tablet 200 from the tablet security system.

The charging clip 150 is attached to the tablet 200 to allow tablets of various shapes and sizes, to be used with the tablet security system 100. In the embodiment shown, a unique charging clip 150 is made for each brand of tablet 200, but a universal charging clip may be used without departing from the invention. The charging clip 150 includes a connector (not shown) that connects to the tablet 200, and another connector (not shown) that attaches to the power connector 160 of the tablet security system 100. In addition to providing power to the tablet 200, the charging clip may also include communications pins (not shown) to allow the tablet to communicate to the tablet security system 100 or other computing system or network. Of course, the tablet 200 may be charged by alternate means including but not limited to inductive charging.

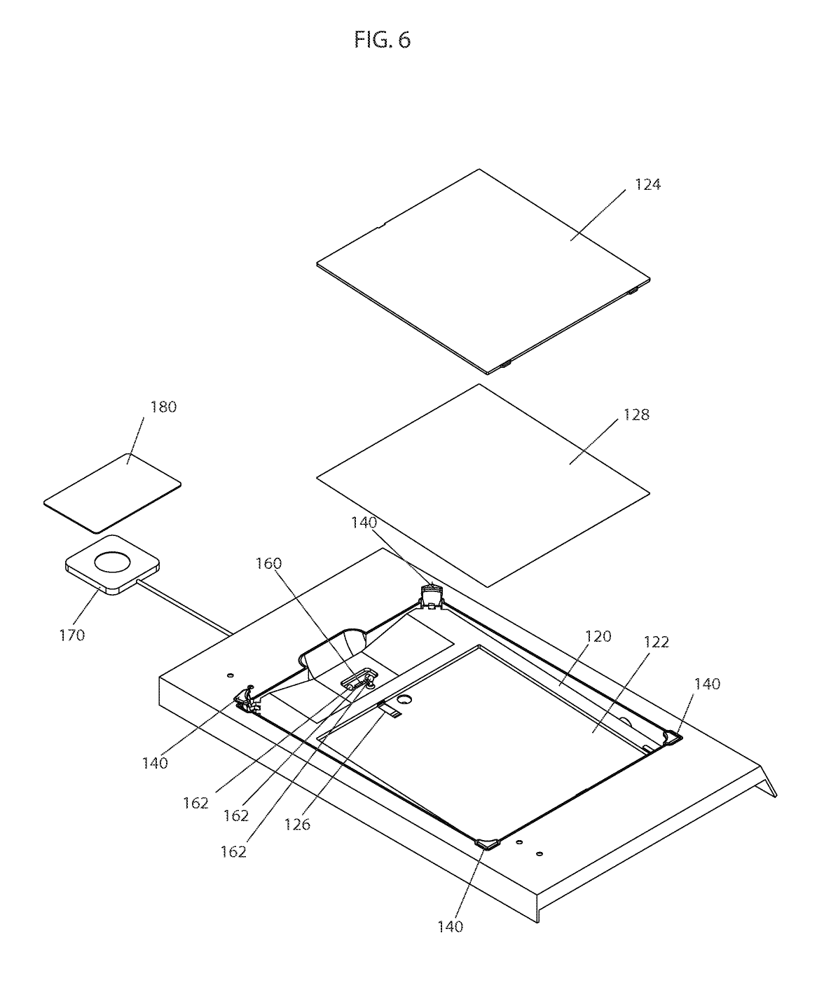

In the embodiment shown, the tablet lift pad 120 includes a recess 122, graphic cover 124, and graphic cover latch 126 for displaying replaceable graphic sheets 128 (See FIG. 6) visible when the tablet 200 is removed from the tablet security system 100. The graphic cover 124 is made of any clear material, but in the embodiment shown, it is made of plastic. The graphic cover latch 126 is attached to the tablet lift pad 120 and secures the graphics cover to the tablet lift pad. The inclusion of the recess 122 and graphic cover 124 allow a retailer to include product information or other graphic material on the tablet lift pad 120 so if an employee removes the tablet, the display still provides customers pertinent information or advertising.

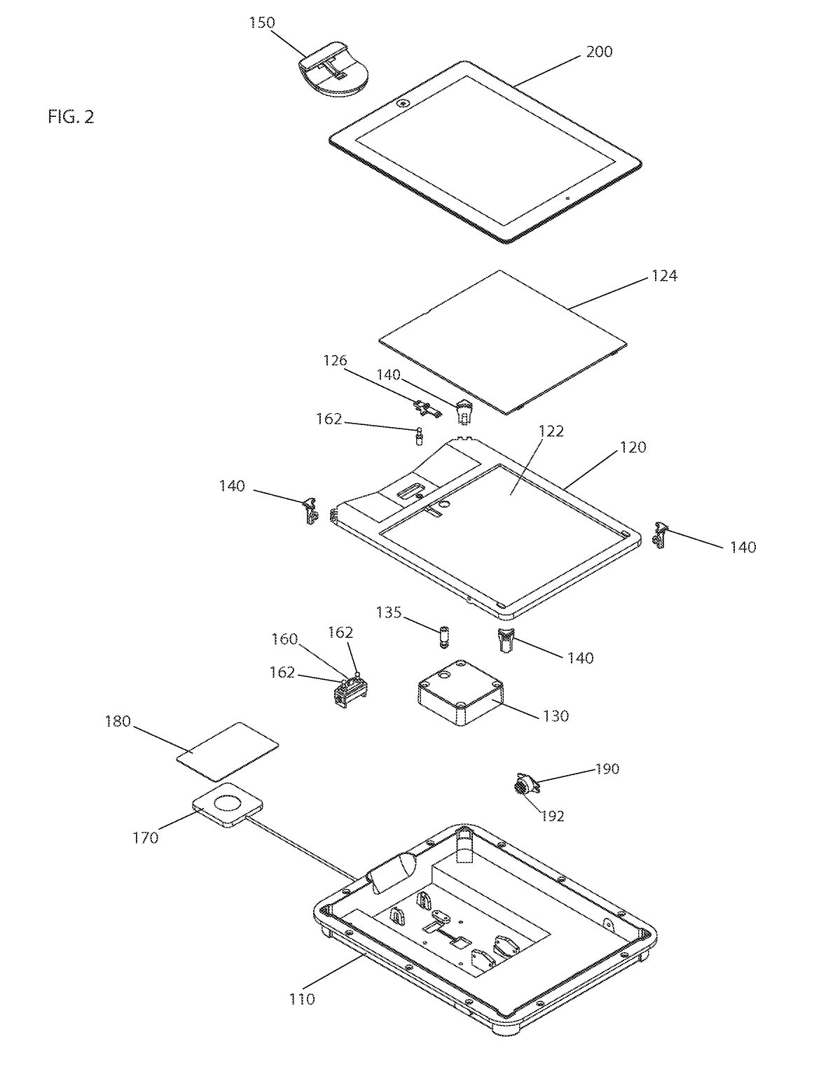

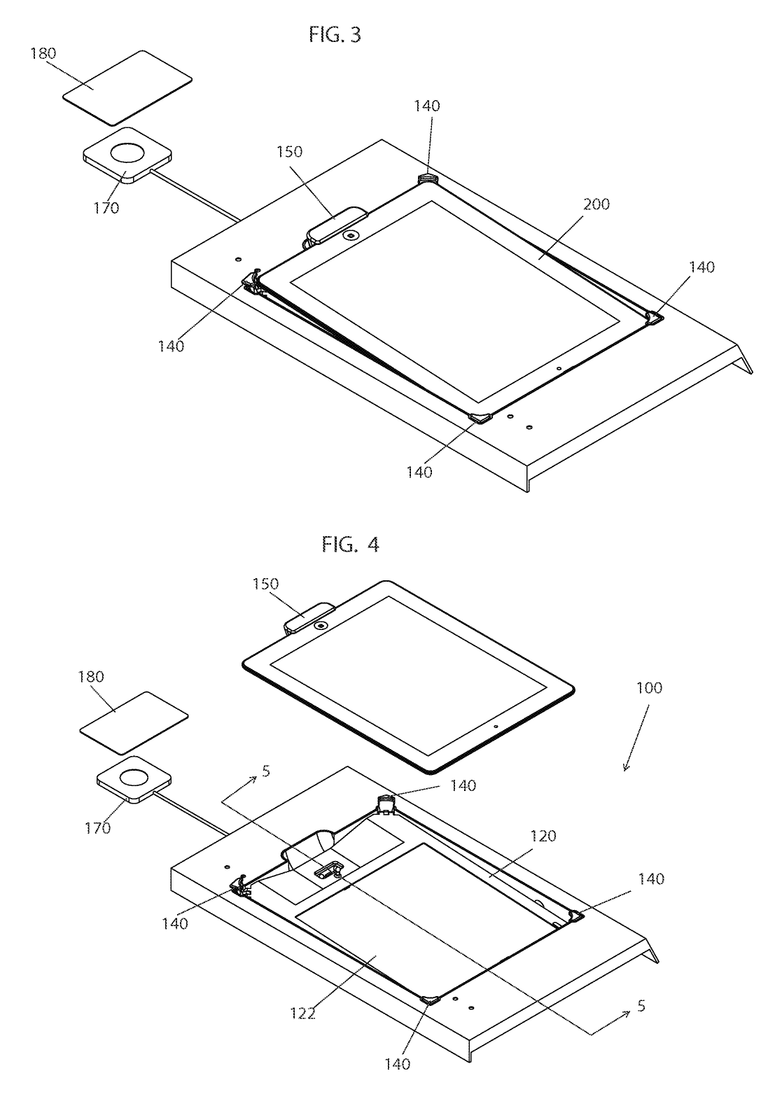

Turning now to FIGS. 3-5, the tablet security system 100 is shown in the unlocked position. To unlock the tablet security system 100, a user swipes the access card 180 near the card reader 170. Of course, other lock mechanisms may be used, including, but not limited to, a key switch, toggle switch, or key pad without departing from the invention. The card reader 170 reads the access card 180, which activates the electronic lock 130. In the embodiment shown, the electronic lock 130 retains a lock pin 135 (see FIG. 2). Upon release of the lock pin, a motor 190 raises the tablet lift pad 120. In the embodiment shown, to raise the tablet lift pad 120, the motor 190 is attached to a gear 192, which is engaged with a series of teeth 194 integrated onto the underside of the tablet lift pad. Other lift mechanisms such as linear actuators, springs, or hydraulic cylinders may also be used without departing from the invention. When the tablet lift pad 120 rises, two of the retention tabs 140 release, allowing the user to remove the tablet 200 from the tablet security system 100.

To secure a tablet 200 to the tablet security system 100, a user first installs the charging clip 150 to the tablet. Next, the user places the tablet 200 on the tablet lift pad 120, making sure that the edges of the tablet are under the retention tabs 140. The user then pushes on the end of the tablet 200 where the charging clip 150 has been installed until the tablet lift pad 120 locks in place, and the retention tabs 140 secure the tablet. When the tablet 200 is installed in the tablet security system, the charging clip 150 connects to a power connector 160 in the housing 110. In the embodiment shown, the power connector 160 includes a mini-usb connector, but any connector may be used without departing from the invention. To help guide the charging clip 150 into the correct position with respect to the power connector 160, a plurality of guide pins 162 engage corresponding guide holes (not shown) in the charging clip as the tablet 200 is secured in the tablet security system 100.

In an alternative embodiment, in addition to providing power to the tablet 200, the tablet security system 100 includes communications components allowing the tablet security system to communicate with the tablet and/or a central server via a typical computer network to provide updated product information, or to send and receive customer configurations or other information.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. An electronic device security system comprising:
a housing;
a tablet lift pad connected to the housing by at least one hinge and configured to support an electronic device;
an electronic lock attached to the housing beneath the tablet lift pad, the electronic lock configured to selectively lock or unlock the tablet lift pad to the housing;
a switch that unlocks the electronic lock;
a tablet lift mechanism connected to the housing that lifts the tablet lift pad to a raised position when the electronic lock is unlocked; and
a plurality of retention tabs for securing the electronic device to the tablet lift pad when the tablet lift pad is in a locked position.

2. The device security system of claim 1, further including a power connector for providing power to the electronic device; and
a charging clip connected to the electronic device that adapts a connector on the tablet computer to connect to the power connector.

3. The electronic device security system of claim 1, wherein the electronic lock includes a pin that is selectively secured with a servo operated tab.

4. The electronic device security system of claim 1, wherein the switch is actuated by a radio frequency identification card.

5. The electronic device security system of claim 1, wherein the switch is operated with a key.

6. The electronic device security system of claim 1, wherein the power connector provides power to the charging clip by magnetic induction.

7. The electronic device security system of claim 1, wherein the tablet lift mechanism includes an electric motor having a drive gear that engages teeth integrally formed into the tablet lift pad.

8. The electronic device security system of claim 1, wherein the tablet lift mechanism includes a linear actuator attached to the tablet lift pad.

9. A method of using an electronic device security system comprising the steps of:
installing a charging clip onto the electronic device;
providing a housing having a tablet lift pad connected to the housing by at least one hinge and configured to support the electronic device;
providing an electronic lock attached to the housing beneath the tablet lift pad, the electronic lock configured to selectively lock and unlock the tablet lift pad to the housing;
providing a switch that locks and unlocks the electronic lock;
providing a tablet lift mechanism connected to the housing that lifts the tablet lift pad to a raised position when the electronic lock is unlocked;
providing a plurality of retention tabs for securing the electronic device to the tablet lift pad when the tablet lift pad is in a locked position;
providing a power connector for providing power to the electronic device;
placing the tablet computer onto the tablet lift pad so that the electronic device rests under the retention tabs; and
pushing on the electronic device to engage the tablet lift pad with the electronic lock.

10. The method of using a tablet security system of claim 9, further comprising the steps of:
actuating the switch to unlock the electronic lock; and
moving the tablet lift pad to the raised position using the tablet lift mechanism.
